(19) United States
(12) Patent Application Publication
(10) Pub. No.: US 2014/0293809 A1
(43) Pub. Date: Oct. 2, 2014

(54) METHOD AND APPARATUS OF CONTROLLING MAC-LAYER PROTOCOL FOR DEVICE-TO-DEVICE COMMUNICATIONS WITHOUT ID

(71) Applicant: Electronics and Telecommunications Research Institute, Daejeon (KR)

(72) Inventors: Soo Chang Kim, Daejeon (KR); Byung Jae Kwak, Daejeon (KR); Seon Ae Kim, Chungcheongbuk-do (KR); Young Hoon Kim, Daejeon (KR); Seung Chan Bang, Daejeon (KR)

(73) Assignee: Electronics and Telecommunications Research Institute, Daejeon (KR)

(21) Appl. No.: 14/223,590

(22) Filed: Mar. 24, 2014

(30) Foreign Application Priority Data
Mar. 26, 2013 (KR) 10-2013-0031921

(51) Int. Cl. H04W 76/02; H04W 56/00; H04W 64/00

(52) U.S. Cl. CPC H04W 76/023; H04W 64/00; H04W 56/001
USPC 370/252; 370/328

(57) ABSTRACT

An apparatus and method for enabling a device-to-device (D2D) communication, despite an identifier (ID) of a target device being unknown are provided. The apparatus may include a target device determining unit to select primary target devices based on relative distance information between a main device and a target device for communication with the main device, and to determine a final target device based on relative distance information between the main device and each of the primary target devices, a transmitter to transmit, to each of the primary target devices, a selection notification message and a relative distance information request message that are generated by the target device determining unit, and a receiver to receive, from each of the primary target devices, a response message corresponding to the selection notification message, and relative distance information used to determine a final target device.

### CROSS-REFERENCE TO RELATED APPLICATION

This application claims the benefit of Korean Patent Application No. 10-2013-0031921, filed on Mar. 26, 2013, in the Korean Intellectual Property Office, the disclosure of which is incorporated herein by reference.

### BACKGROUND

1. Field of the Invention

The present invention relates to a media access control (MAC) layer protocol control apparatus and method for enabling a device-to-device (D2D) communication, despite an identifier (ID) of a target device being unknown.

2. Description of the Related Art

In a wireless communication system, numbers are most typically used to select a target and perform communication. For example, in a mobile phone, communication may be performed using a telephone number of a counterpart. The telephone number is very conveniently used when the counterpart is not viewed. However, when the counterpart is viewed, but the telephone number is not known, the telephone number needs to be found by any means, which may cause inconvenience.

Bluetooth may enable communication to be performed in a short distance when a number of a counterpart is unknown. However, neighboring Bluetooth-enabled objects need to be examined, instead of the number, and a counterpart needs to be selected from among the Bluetooth enabled objects, which may cause inconvenience. Additionally, since all Bluetooth enabled objects need to be examined, it seems to be a bit extravagant, compared to a direct communication with a target device. Accordingly, performing communication by increasing a distance may also cause inconvenience.

Recently mentioned Wi-Fi Direct may overcome a disadvantage of a short distance of Bluetooth, and may increase a distance. However, since a counterpart may be selected by numbers, or by examination of surroundings, inconvenience may occur when communication is to be performed without advance information. When communication is performed by attaching a bar code or marking means corresponding to the bar code to an object, a database may be required for a one-to-one match between each object and marking means. However, it may be very difficult to apply the database to various objects, for example electronic equipment, buildings, people, and the like. Additionally, the marking means may be applied only passively to a means of acquiring information from an object. A radio frequency identification (RFID) may include both a means of acquiring information from an object, and a means of performing communication with each other. However, since a database for a one-to-one match between an object and an RFID is required, similarly to the bar code, inconvenience may occur.

When a communication link between devices is set, a scheme of selecting a device with which communication is to be performed, based on a name or address of the device may be complicated, not intuitively, or the name or address may need to be detected. To solve the above problem, a separate additional communication channel may be generated, using an RFID, infrared data association (IrDA), ultrasonic waves, Wi-Fi, and the like. A main device may personally select a target device for communication with the main device, using an RFID and IrDA beam, may exchange a unique ID of the target device through an additional communication channel, and may set a device-to-device (D2D) communication link. When the D2D communication link is normally set, a D2D communication may be performed using an existing wireless communication technology with an excellent transmission capability, for example Wi-Fi, Bluetooth, and the like.

### SUMMARY

In the present invention, a main device may select a target device using a terminal of the main device, while monitoring a screen that displays various target devices, for example a mobile terminal, a printer, a beam projector, a shop sign, and the like, focused on by a camera, despite an identifier (ID) of the target device being unknown. Additionally, a recognition distance of a target device enabling communication may be increased, and an unnecessary communication amount may be reduced and accordingly, a quick search time may be ensured. An inconvenient process of searching for a neighboring target in Bluetooth or Wi-Fi Direct, may be reduced. A protocol control method performed in a media access control (MAC) layer to support the above communication scheme may be described.

According to an aspect of the present invention, there is provided a MAC layer protocol control apparatus, including: a target device determining unit to select primary target devices based on relative distance information regarding a relative distance between a main device and a target device for communication with the main device, and to determine a final target device based on relative distance information regarding a relative distance between the main device and each of the primary target devices; a transmitter to transmit, to each of the primary target devices, a selection notification message and a relative distance information request message that are generated by the target device determining unit; and a receiver to receive, from each of the primary target devices, a response message corresponding to the selection notification message, and relative distance information used to determine a final target device.

The target device determining unit may include a target device recognition processor to select primary target devices from among neighboring devices, a relative distance information requester to measure a distance between the primary target devices selected by the target device recognition processor, a collision processor to control data to be transmitted without collision of the data, and a synchronization processor to perform synchronization between the main device and primary target devices.

The target device recognition processor may select an image representing the target device for communication with the main device through a screen of the main device, and may store the relative distance information regarding the relative distance between the main device and the target device.

The target device recognition processor may select primary target devices within a preset angle from among the neighboring devices, using a directional beam, and may generate a selection notification message to be transmitted to each of the primary target devices.

The target device recognition processor may determine a final target device, based on relative distance information received from each of the primary target devices.

The relative distance information requester may generate a relative distance information request message to be transmitted to each of the primary target devices, to measure a relative distance between the main device and each of the primary target devices selected by the target device recognition processor.

The synchronization processor may transmit time information of the main device to the primary target devices at regular intervals, and the primary target devices may maintain synchronization based on the time information.

According to another aspect of the present invention, there is provided a MAC layer protocol control apparatus, including: a message receiver to receive a selection notification message and a relative distance information request message from a main device; a relative distance information generator to generate relative distance information, based on the received relative distance information request message, the relative distance information being used to measure a distance from the main device to a target device; and a message transmitter to transmit the generated relative distance information, and a response message corresponding to the selection notification message.

The relative distance information generator may generate the relative distance information, based on a time in which the main device transmits the relative distance information request message, and a time in which the target device receives the relative distance information request message.

According to another aspect of the present invention, there is provided a MAC layer protocol control method, including: selecting, by a main device, primary target devices, and transmitting a selection notification message to each of the primary target devices; transmitting, by each of the primary target devices, a response message corresponding to the selection notification message to the main device; and determining, by the main device, a final target device among the primary target devices, in response to the response message.

The MAC layer protocol control method may further include selecting, by the main device, an image representing a target device for communication with the main device, through a screen of the main device, and storing relative distance information regarding a relative distance between the main device and the target device.

The selecting may include selecting, by the main device, as primary target devices, target devices within a preset angle from among neighboring devices, using a directional beam.

The determining may include transmitting, by the main device, a relative distance information request message to each of the primary target devices, in response to the response message, transmitting, by each of the primary target devices, relative distance information to the main device, in response to the relative distance information request message, and determining, by the main device, the final target device based on the received relative distance information.

The transmitting of the relative distance information to the main device may include measuring a period of time from a time in which the main device transmits the relative distance information request message to a time in which each of the primary target device receives the relative distance information request message, generating relative distance information, and transmitting the generated relative distance information to the main device.

The determining of the final target device based on the received relative distance information may include determining, to be the final target device, a target device corresponding to relative distance information that is most closely matched to relative distance information associated with the final target device, among the received relative distance information, the relative distance information associated with the final target device being stored in advance.

### EFFECT

Conventionally, devices, such as smart phones, may typically communicate with neighboring devices, only when an ID is known. According to embodiments of the present invention, when a main device merely selects a target device using a camera of the main device, a device desired by the main device may be found and communication may be performed. The device may perform a function and procedure in a media access control (MAC) layer. Unlike an existing scheme, in embodiments of the present invention, a main device may process a main protocol in a MAC layer, so that communication may be performed with all devices in view even when an ID of a final target device is unknown. Accordingly, a processing time may be efficiently reduced. Additionally, people-oriented communication may be implemented, instead of mechanic-oriented communication.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a configuration of a main device in a media access control (MAC) layer protocol control apparatus according to an embodiment of the present invention;

FIG. 2 is a block diagram illustrating a configuration of a target device determining unit in the main device of FIG. 1;

FIG. 3 is a block diagram illustrating a configuration of a target device in a MAC layer protocol control apparatus according to an embodiment of the present invention;

FIG. 4 is a flowchart illustrating a MAC layer protocol control method according to an embodiment of the present invention;

FIG. 5 is a flowchart illustrating an operation of determining a final target device in the MAC layer protocol control method of FIG. 4; and

FIG. 6 is a diagram illustrating an example of an exchange of messages in a MAC layer control for a device-to-device (D2D) communication according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

In a media access control (MAC) layer protocol control apparatus and method according to embodiments of the present invention, a device-to-device (D2D) communication with a target device may be performed without support of an access point (AP) or a base station, despite an identifier (ID) of a device being unknown. Hereinafter, embodiments of the present invention will be further described with reference to the accompanying drawings.

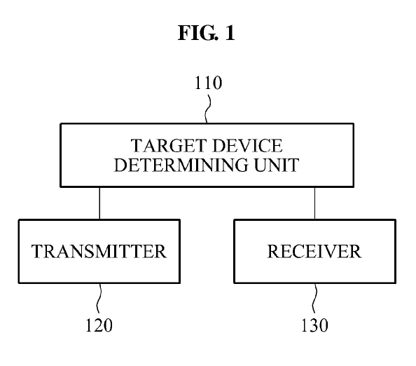

FIG. 1 is a diagram illustrating a configuration of a main device in a MAC layer protocol control apparatus according to an embodiment of the present invention.

Referring to FIG. 1, the main device may include a target device determining unit 110, a transmitter 120, and a receiver 130.

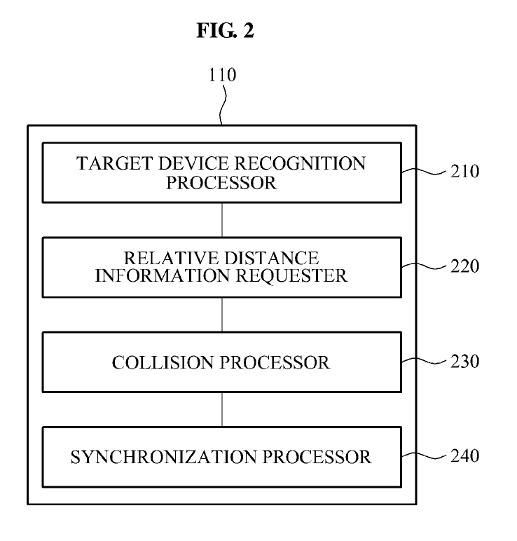

The target device determining unit 110 may select primary target devices based on relative distance information regarding a relative distance between the main device and a target device for communication with the main device, and may determine a final target device based on relative distance information regarding a relative distance between the main device and each of the primary target devices. The target device determining unit 110 will be further described with reference to FIG. 2.

The transmitter 120 may transmit, to each of the primary target devices, a selection notification message and a relative distance information request message that are generated by the target device determining unit 110. The transmitter 120 may transmit a message to an Internet protocol (IP) or an application layer, and may transmit, to a target device, a message of a MAC layer and a message of an upper layer to process a command of the main device. Additionally, the transmitter 120 may transmit a message used to determine whether a physical layer and a channel are busy, a message for synchronization, a message used to process a beam for recognition of a target device, and a message used to measure relative distance information.

The receiver 130 may receive, from each of the primary target devices, a response message corresponding to the selection notification message, and relative distance information used to determine a final target device. Additionally, the receiver 130 may receive the message used to determine whether a physical layer and a channel are busy, the message for synchronization, the message used to process a beam for recognition of a target device, and the message used to measure relative distance information.

FIG. 2 is a block diagram illustrating a configuration of the target device determining unit 110 of FIG. 1.

Referring to FIG. 2, the target device determining unit 110 may include a target device recognition processor 210, a relative distance information requester 220, a collision processor 230, and a synchronization processor 240.

The target device recognition processor 210 may select primary target devices from among neighboring devices. The target device recognition processor 210 may select an image representing the target device for communication with the main device through a screen of the main device, and may store, in advance, the relative distance information regarding the relative distance between the main device and the target device. Additionally, the target device recognition processor 210 may select primary target devices within a preset angle from among neighboring devices, using a directional beam, and may generate a selection notification message to be transmitted to the primary target devices. The preset angle may be determined based on the stored relative distance information.

In addition, a final target device may be determined based on the relative distance information regarding the relative distance between the main device and each of the primary target devices. The target device recognition processor 210 may measure a relative distance from the main device to each of the primary target devices, based on information regarding a time in which the main device transmits the relative distance information request message, and a time in which each of the primary target devices receives the relative distance information request message. The information regarding the times may be included in the received relative distance information. A target device corresponding to relative distance information that is most closely matched to relative distance information associated with the target device for communication with the main device, among the relative distance information regarding the relative distance between the main device and each of the primary target devices may be determined to be the final target device. The relative distance information associated with the target device may be stored, in advance, in the main device.

Accordingly, to determine a target device for communication with the main device when an ID of the target device is unknown, the target device recognition processor 210 may perform a process of mechanically searching for the target device selected by the main device.

The relative distance information requester 220 may generate a relative distance information request message to measure the relative distance between the main device and each of the primary target devices selected by the target device recognition processor 210.

The collision processor 230 may control data to be transmitted without collision of the data. The collision processor 230 may perform a unique function in a MAC, that is, may process data to be transmitted through a wireless channel without collision of the data. When data collides, the collision processor 230 may process data to be retransmitted after waiting for at least a preset period of time.

The synchronization processor 240 may perform synchronization between the main device and the primary target devices. To measure the relative distance between the main device and each of the primary target devices, synchronization between the main device and the primary target devices may be required. Accordingly, the synchronization processor 240 may perform the synchronization between the main device and the primary target devices. Additionally, without support of a base station or an AP, the synchronization between the main device and the primary target devices may be performed. Neighboring devices maintaining the synchronization may include, for example, all devices other than the main device that communicate with the main device.

When the image representing the target device is selected through the screen of the main device, the synchronization processor 240 may initiate communication with the neighboring devices. Additionally, the synchronization processor 240 may determine a final target device from among the neighboring devices through the communication with the neighboring devices. In this instance, the synchronization processor 240 may transmit time information of the main device to the primary target devices at regular intervals. The primary target devices may maintain synchronization based on the time information.

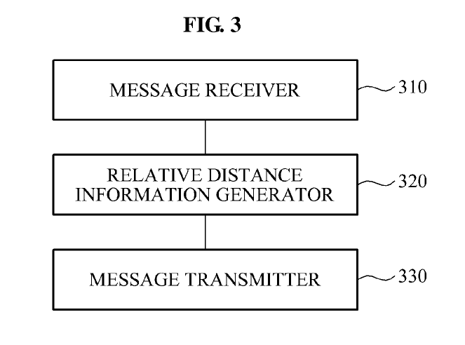

FIG. 3 is a block diagram illustrating a configuration of a target device in a MAC layer protocol control apparatus according to an embodiment of the present invention.

Referring to FIG. 3, the target device may include a message receiver 310, a relative distance information generator 320, and a message transmitter 330.

The message receiver 310 may receive a selection notification message and a relative distance information request message from a main device.

The relative distance information generator 320 may generate relative distance information, based on the relative distance information request message received by the message receiver 310. In this instance, the target device may generate relative distance information, based on a time in which the main device transmits the relative distance information request message, and a time in which the target device receives the relative distance information request message.

The message transmitter 330 may transmit the relative distance information, and a response message corresponding to the selection notification message. Specifically, the message transmitter 330 may transmit, to the main device, the response message corresponding to the selection notification message received from the main device, and the relative distance information generated by the relative distance information generator 320.

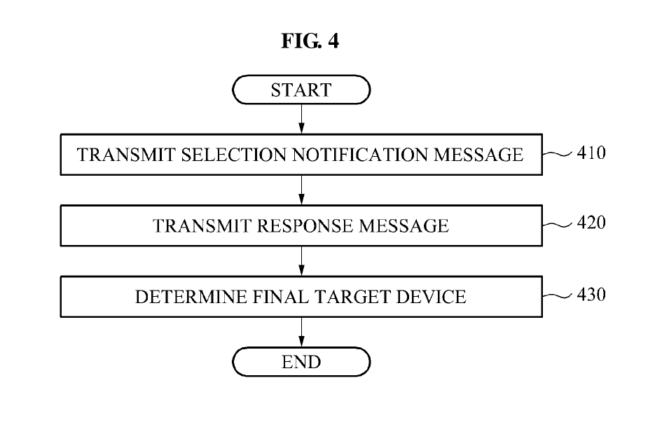

FIG. 4 is a flowchart illustrating a MAC layer protocol control method according to an embodiment of the present invention.

Referring to FIG. 4, in operation 410, a main device may select primary target devices, and may transmit a selection notification message to each of the primary target devices. In this instance, the main device may select an image representing a target device for communication with the main device, through a screen of the main device. Additionally, the main device may store, in advance, relative distance information regarding a relative distance between the main device and each of the primary target devices. The main device may select, as primary target devices, target devices within a preset angle from among neighboring devices, using a directional beam. The preset angle may be obtained using the stored relative distance information. The main device may transmit a selection notification message to each of the target devices selected as the primary target devices.

In operation 420, each of the primary target devices receiving the selection notification message in operation 410 may transmit a response message corresponding to the selection notification message to the main device. In response to the selection notification message, the primary target devices may determine that the primary target devices are included in a candidate group for the target device for communication, and may transmit a response message corresponding to the selection notification message to the main device.

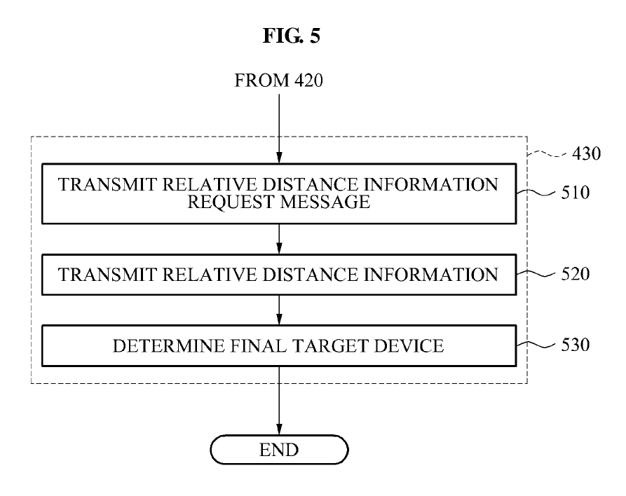

In operation 430, the main device receiving the response message may determine a final target device among the primary target devices. In response to the response message of operation 420, the main device may transmit a relative distance information request message to each of the primary target devices. In response to the relative distance information request message, the primary target devices may transmit relative distance information to the main device. Additionally, the main device may determine a final target device, based on the received relative distance information. Operation 430 will be further described with reference to FIG. 5.

FIG. 5 is a flowchart illustrating operation 430 of FIG. 4.

When the response message is received in operation 420, the main device may transmit the relative distance information request message to each of the primary target devices in operation 510.

When the relative distance information request message is received, the primary target devices may transmit relative distance information to the main device in operation 520. In this instance, each of the primary target devices may measure a period of time from a time in which the main device transmits the relative distance information request message to a time in which each of the primary target devices receives the relative distance information request message, and may generate relative distance information. The primary target devices may transmit the generated relative distance information to the main device.

In operation 530, the main device may determine a final target device, based on the relative distance information received in operation 520. The main device may measure a relative distance between the main device and each of the primary target devices, based on information regarding the time in which the main device transmits the relative distance information request message, and the time in which each of the primary target devices receives the relative distance information request message. The information regarding the times may be included in the received relative distance information. The main device may determine, to be a final target device, a target device corresponding to relative distance information that is most closely matched to relative distance information associated with the target device for communication, among the received relative distance information. The relative distance information associated with the target device may be stored in advance in the main device.

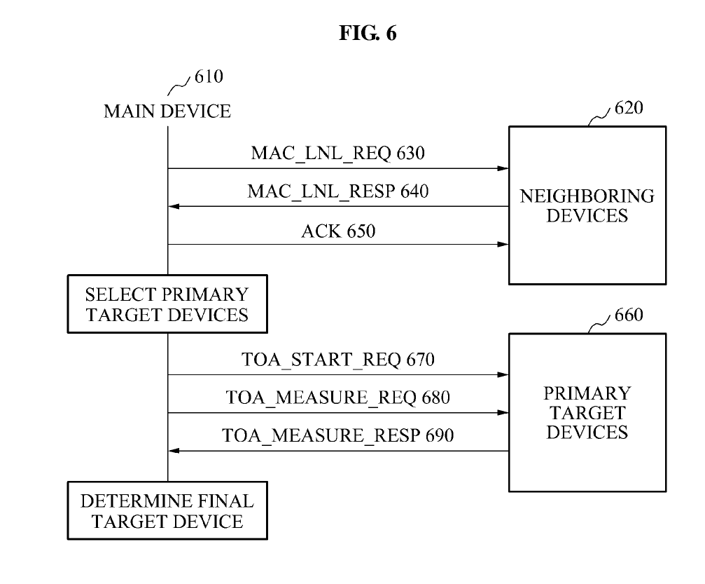

FIG. 6 is a diagram illustrating an example of an exchange of messages in a MAC layer control for a device-to-device (D2D) communication according to an embodiment of the present invention.

In FIG. 6, messages MAC_LNL_REQ 630, MAC_LNL_RESP 640, and ACK 650 may be exchanged, however, there is no limitation thereto. Accordingly, messages corresponding to the messages MAC_LNL_REQ 630, MAC_LNL_RESP 640, and ACK 650 may be exchanged.

Referring to FIG. 6, a main device 610 may transmit the message MAC_LNL_REQ 630 to neighboring devices 620. Neighboring devices receiving the message MAC_LNL_REQ 630 among the neighboring devices 620 may determine that they are included in a candidate group of primary target devices for direct communication with the main device 610 without an ID. The neighboring devices receiving the message MAC_LNL_REQ 630 may include a correlation value of the received message MAC_LNL_REQ 630 in the message MAC_LNL_RESP 640, and may transmit the message MAC_LNL_RESP 640 to the main device 610.

The main device 610 may select neighboring devices having correlation values that are equal to or greater than a preset threshold, from among the neighboring devices transmitting the message MAC_LNL_RESP 640. For example, a plurality of neighboring devices coexisting in a dense region may be selected. The main device 610 may transmit the message ACK 650 to notify that the message MAC_LNL_RESP 640 is received from the neighboring devices.

When the message ACK 650 is transmitted, the main device 610 may select primary target devices 660. The main device 610 may request the primary target devices 660 to transmit relative distance information. The main device 610 may transmit a relative distance information request message TOA_START_REQ 670 used to request the relative distance information.

When the relative distance information request message TOA_START_REQ 670 is transmitted, the main device 610 may transmit, to each of the primary target devices 660, a message TOA_MEASURE_REQ 680 used to measure a relative distance between the main device 610 and each of the primary target devices 660. In response to the message TOA_MEASURE_REQ 680, each of the primary target devices 660 may include information regarding a time in which the message TOA_MEASURE_REQ 680 is transmitted and regarding a time in which the message TOA_MEASURE_REQ 680 is received, in relative distance information TOA_MEASURE_RESP 690, and may transmit the relative distance information TOA_MEASURE_RESP 690 to the main device 610.

The main device 610 may measure a relative distance from the main device 610 to each of the primary target devices 660, based on the information regarding the times included in the relative distance information TOA_MEASURE_RESP 690. When the relative distance is measured, the main device 610 may determine, to be a final target device, a target device corresponding to relative distance information that is most closely matched to relative distance information associated with a target device for communication, among the primary target devices 660. The relative distance information associated with the target device for communication may be stored in advance in the main device 610. Additionally, the main device 610 may report the final target device to a user, and may start actual communication in response to a user's request.

The above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A media access control (MAC) layer protocol control apparatus, comprising:
a target device determining unit to select primary target devices based on relative distance information regarding a relative distance between a main device and a target device for communication with the main device, and to determine a final target device based on relative distance information regarding a relative distance between the main device and each of the primary target devices;
a transmitter to transmit, to each of the primary target devices, a selection notification message and a relative distance information request message that are generated by the target device determining unit; and
a receiver to receive, from each of the primary target devices, a response message corresponding to the selection notification message, and relative distance information used to determine a final target device.

2. The MAC layer protocol control apparatus of claim 1, wherein the target device determining unit comprises:
a target device recognition processor to select primary target devices from among neighboring devices;
a relative distance information requester to measure a distance between the primary target devices selected by the target device recognition processor;
a collision processor to control data to be transmitted without collision of the data; and
a synchronization processor to perform synchronization between the main device and primary target devices.

3. The MAC layer protocol control apparatus of claim 2, wherein the target device recognition processor selects an image representing the target device for communication with the main device through a screen of the main device, and stores the relative distance information regarding the relative distance between the main device and the target device.

4. The MAC layer protocol control apparatus of claim 3, wherein the target device recognition processor selects primary target devices within a preset angle from among the neighboring devices, using a directional beam, and generates a selection notification message to be transmitted to each of the primary target devices.

5. The MAC layer protocol control apparatus of claim 2, wherein the target device recognition processor determines a final target device, based on relative distance information received from each of the primary target devices.

6. The MAC layer protocol control apparatus of claim 2, wherein the relative distance information requester generates a relative distance information request message to be transmitted to each of the primary target devices, to measure a relative distance between the main device and each of the primary target devices selected by the target device recognition processor.

7. The MAC layer protocol control apparatus of claim 2, wherein the synchronization processor transmits time information of the main device to the primary target devices at regular intervals, and the primary target devices maintain synchronization based on the time information.

8. A media access control (MAC) layer protocol control apparatus, comprising:
a message receiver to receive a selection notification message and a relative distance information request message from a main device;
a relative distance information generator to generate relative distance information, based on the received relative distance information request message, the relative distance information being used to measure a distance from the main device to a target device; and
a message transmitter to transmit the generated relative distance information, and a response message corresponding to the selection notification message.

9. The MAC layer protocol control apparatus of claim 8, wherein the relative distance information generator generates the relative distance information, based on a time in which the main device transmits the relative distance information request message, and a time in which the target device receives the relative distance information request message.

10. A media access control (MAC) layer protocol control method, comprising:
selecting, by a main device, primary target devices, and transmitting a selection notification message to each of the primary target devices;
transmitting, by each of the primary target devices, a response message corresponding to the selection notification message to the main device; and
determining, by the main device, a final target device among the primary target devices, in response to the response message.

11. The MAC layer protocol control method of claim 10, further comprising:
selecting, by the main device, an image representing a target device for communication with the main device, through a screen of the main device, and storing relative distance information regarding a relative distance between the main device and the target device.

12. The MAC layer protocol control method of claim 10, wherein the selecting comprises selecting, by the main device, as primary target devices, target devices within a preset angle from among neighboring devices, using a directional beam.

13. The MAC layer protocol control method of claim 10, wherein the determining comprises:
transmitting, by the main device, a relative distance information request message to each of the primary target devices, in response to the response message;
transmitting, by each of the primary target devices, relative distance information to the main device, in response to the relative distance information request message; and
determining, by the main device, the final target device based on the received relative distance information.

14. The MAC layer protocol control method of claim 13, wherein the transmitting of the relative distance information to the main device comprises measuring a period of time from a time in which the main device transmits the relative distance information request message to a time in which each of the primary target device receives the relative distance information request message, generating relative distance information, and transmitting the generated relative distance information to the main device.

15. The MAC layer protocol control method of claim 13, wherein the determining of the final target device based on the received relative distance information comprises determining, to be the final target device, a target device corresponding to relative distance information that is most closely matched to relative distance information associated with the final target device, among the received relative distance information, the relative distance information associated with the final target device being stored in advance.
